(19) United States
(12) Patent Application Publication
(10) Pub. No.: US 2011/0060481 A1
(43) Pub. Date: Mar. 10, 2011

(54) ANTITHEFT METHOD AND SYSTEM FOR MOTORCYCLES

(75) Inventors: Dong Seok KANG, Busan (KR); Kyoung Moon LEE, Busan (KR); Young Chang KIM, Busan (KR); Jae Pyung KO, Yangsan-si (KR); Young Tak KIM, Busan (KR)

(73) Assignee: Dong-A University Research Foundation for Industry-Academy Cooperation, Busan (KR)

(21) Appl. No.: 12/877,763

(22) Filed: Sep. 8, 2010

(30) Foreign Application Priority Data
Sep. 8, 2009 (KR) 10-2009-0084618
Oct. 7, 2009 (KR) 10-2009-0095157

(51) Int. Cl. G06F 19/00

(52) U.S. Cl. 701/2

(57) ABSTRACT

An antitheft method and system for motorcycles are provided. The antitheft method and system for motorcycles authenticate an electronic identifier when power-up of a motorcycle or engine start-up is sensed and cut off the power-up or engine start-up if the power-up or engine start-up is not authenticated. An electronic control unit can generate a theft alarm signal in case of unauthenticated power-up or engine start-up. The motorcycle engine is automatically stopped if the engine is started through an illegal method, and thus the motorcycle is prevented from being stolen. Further, a user can confirm the electronic identifier and start the motorcycle without inserting a key into a key cylinder, and thus the user can start the motorcycle easily and rapidly.

### BACKGROUND OF THE INVENTION

1.Field of the Invention

The present invention relates to an antitheft method and system for motorcycles, and more particularly, to an antitheft method and system for motorcycles for rapidly starting a motorcycle without having a physical key and, when unauthorized power-up or engine start-up is detected, cutting off the unauthorized power-up or stopping engine start-up to prevent the motorcycle from being stolen.

2. Discussion of the Related Art

Generally, it is required to insert a key into a key cylinder, turn the key, and then press a start button or step on a kick start in order to start a motorcycle. However, this procedure is inconvenient for a user to start the motorcycle because the user must carry the key, insert the key into the key cylinder and turn the key cylinder to ‘ON’ position.

Motorcycles are exposed to danger of theft all the time because the motorcycles are easily accessible by people. Further, most of motorcycles have a problem that their engines can be forcibly started by operating wiring through an illegal method. For example, a motorcycle engine is started when a connector connecting a key cylinder with harnesses is separated and a kick start is hit, a wire harness is cut and the kick start is hit, or one of an ignition ground or an ignition wire is cut and the kick start is hit.

Recently, a smart key system which easily starts motorcycles and improves an antitheft technique has been widely applied to motorcycles. However, the smart key system can be applied to most of motorcycles only in a manufacturing step and motorcycles equipped with the smart key system become expensive due to system complexity and a large number of components. Moreover, when wiring of a motorcycle is operated through an illegal method to start the motorcycle, it is difficult to detect the start-up of the motorcycle.

### SUMMARY OF THE INVENTION

It is an object of the present invention to provide an antitheft method and system for motorcycles for detecting power-up of a motorcycle or engine start-up performed through an illegal method and cutting off the power-up or engine start-up.

It is another object of the present invention to provide an antitheft method and system for motorcycles for generating a theft alarm signal when an unauthorized power-up or engine start-up is detected.

It is still another object of the present invention to provide an antitheft method and system for motorcycles for allowing a user to confirm an electronic identifier and start a motorcycle rapidly and easily without inserting a physical key into a key cylinder.

According to an aspect of the present invention, there is provide an antitheft method for motorcycles, which includes a step in which an electronic control unit senses power-up of a motorcycle or engine start-up before authentication; a step in which the electronic control unit transmits an electronic identifier of the electronic control unit to a smart remote controller through radio communication; and a step in which the electronic control unit cuts off the motorcycle power-up or engine start-up when the electronic control unit does not receive a response signal to the electronic identifier of the electronic control unit from the smart remote controller.

The electronic control unit may generate a theft alarm signal in the step of cutting off the motorcycle power-up or engine start-up.

The electronic control unit may ground the output of an IG control circuit to the ground to ground AC power supplied to an engine ignition controller of the motorcycle to the ground or cut off DC power supplied to the engine ignition controller so as to stop the engine start-up in the step of cutting off the motorcycle power-up or engine start-up.

The antitheft method for motorcycles may further include a step of determining whether the electronic identifier of the electronic control unit, received by the smart remote controller, is identical to the electronic identifier of the smart remote controller; and a step in which the smart remote controller sends no response when the electronic identifier of the electronic control unit is not identical to the electronic identifier of the smart remote controller.

The antitheft method for motorcycles may further include a step in which the smart remote controller transmits a response signal including the electronic identifier of the smart remote controller to the electronic control unit; and a step in which the electronic control unit determines whether the electronic identifier of the smart remote controller, which is included in the response signal, is identical to the electronic identifier of the electronic control unit and, when the electronic identifier of the smart remote controller is identical to the electronic identifier of the electronic control unit, prepares or maintains engine start-up if the electronic identifier of the smart remote controller is identical to the electronic identifier of the electronic control unit.

The antitheft method for motorcycles may further include a step in which the electronic control unit maintains a predetermined handle lock state when the electronic identifier of the smart remote controller is not identical to the electronic identifier of the electronic control unit; and a step in which the electronic control unit cancels the predetermined handle lock state when the electronic identifier of the smart remote controller is identical to the electronic identifier of the electronic control unit.

In the step of transmitting the electronic identifier of the electronic control unit to the smart remote controller, the electronic control unit may transmit the electronic identifier of the electronic control unit to the smart remote controller through radio communication when a pressure sensing signal is received from a pressure sensor attached to a seat of the motorcycle or a braking operation is sensed.

According to another aspect of the present invention, there is provided an antitheft method for motorcycles, which includes a step in which an electronic control unit senses power-up of a motorcycle or engine start-up before authentication; a step in which the electronic control unit requests a smart remote controller to transmit an electronic identifier of the smart remote controller through radio communication; and a step in which the electronic control unit cuts off the motorcycle power-up or engine start-up when the electronic control unit does not receive the electronic identifier of the smart remote controller within a predetermined period of time.

The antitheft method for motorcycles may further include a step in which the electronic control unit receives the electronic identifier of the smart remote controller from the smart remote controller; a step in which the electronic control unit determines whether the electronic identifier of the smart remote controller is identical to the electronic identifier of the electronic control unit; and a step in which the electronic control unit performs the step of cutting off the motorcycle power-up or engine start-up when the electronic identifier of the smart remote controller is not identical to the electronic identifier of the electronic control unit and prepares or maintains engine start-up when the electronic identifier of the smart remote controller is identical to the electronic identifier of the electronic control unit.

The electronic control unit may not start the engine of the motorcycle if a start button is pressed within the predetermined period of time for which the electronic control unit does not receive the response signal or the electronic identifier of the smart remote controller in the step of cutting off the motorcycle power-up or engine start-up.

In the step of requesting the smart remote controller to transmit the electronic identifier of the smart remote controller, the electronic control unit may request the smart remote controller to transmit the electronic identifier of the smart remote controller through radio communication when a pressure sensing signal is received from a pressure sensor attached to a seat of the motorcycle or a braking operation is sensed.

The electronic control unit may sense tilting of the motorcycle to the left or right at greater than a predetermined angle or lifting of the front or rear wheel of the motorcycle at greater than a predetermined angle in the step of sensing the power-up or engine start-up before authentication, and the electronic control unit may generate a theft alarm signal in the step of cutting off the power-up or engine start-up.

The electronic control unit may transmit the theft alarm signal to an authenticated smart remote controller to raise a theft alarm.

According to another aspect of the present invention, there is provided an antitheft system for motorcycles, which includes an electronic control unit and a smart remote controller. The electronic control unit senses motorcycle power-up or engine start-up before authentication and transmits/receives an electronic identifier. The smart remote controller receives an electronic identifier from the electronic control unit, transmits a response signal and determines whether the received electronic identifier of the electronic control unit is identical to an electronic identifier of the smart remote controller. The electronic control unit transmits the electronic identifier of the electronic control unit to the smart remote controller when sensing motorcycle power-up or engine start-up. The smart remote controller receives the electronic identifier of the electronic control unit, determines whether the received electronic identifier of the electronic control unit is identical to the electronic identifier of the smart remote controller, sends no response if the received electronic identifier of the electronic control unit is not identical to the electronic identifier of the smart remote controller, and transmits the response signal including the electronic identifier of the smart remote controller to the electronic control unit if the received electronic identifier of the electronic control unit is identical to the electronic identifier of the smart remote controller. The electronic control unit cuts off motorcycle power-up or engine start-up if the response signal is not received within a predetermined time, determines whether the electronic identifier of the smart remote controller, which is included in the response signal, is identical to the electronic identifier of the electronic control unit if the response signal is received, and prepares or maintains engine start-up when the electronic identifier of the smart remote controller is identical to the electronic identifier of the electronic control unit. The electronic control unit may generate a theft alarm signal when the response signal is not received within the predetermined time.

The electronic control unit may include a sensing unit, a first controller and a first radio communication unit. The sensing unit senses motorcycle power-up or engine start-up. The first controller determines whether the electronic identifier of the smart remote controller is identical to the electronic identifier of the electronic control unit. The first radio communication unit transmits/receives the electronic identifiers.

The smart remote controller includes a second radio communication unit and a second controller. The second radio communication unit receives the electronic identifier of the electronic control unit and transmits the response signal. The second controller determines whether the electronic identifier of the smart remote controller is identical to the electronic identifier of the electronic control unit.

The electronic control unit may ground the output of an IG control circuit to the ground to ground AC power supplied to an engine ignition controller of the motorcycle to the ground or cut off DC power supplied to the engine ignition controller so as to stop the engine start-up in the step of cutting off the motorcycle power-up or engine start-up.

The electronic control unit may maintain a sleep state while the motorcycle engine is cut off.

The electronic control unit may check a battery voltage of the motorcycle and notify a user of a battery change time.

The smart remote controller may maintain a sleep state until an electronic identifier request signal is received from the electronic control unit.

The smart remote controller may send no response when an electronic control unit other than an authenticated electronic control unit requests the smart remote controller to transmit the electronic identifier.

The smart remote controller may check a battery voltage of the smart remote controller and notify a user of a battery change time.

The antitheft method and system for motorcycles according to the present invention can detect power-up of a motorcycle or engine start-up performed through an illegal method and cut off the power-up or engine start-up. Further, the antitheft method and system for motorcycles according to the present invention can generate a theft alarm signal when unauthenticated power-up or engine start-up is detected. Accordingly, the motorcycle can be prevented from being stolen.

Moreover, the antitheft method and system for motorcycles according to the present invention can confirm an electronic identifier and start the motorcycle without inserting a physical key into a key cylinder, and thus a user can start the motorcycle easily and rapidly.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 is a block diagram of an electronic control unit according to an embodiment of the present invention;

FIG. 2 is a block diagram of a smart remote controller according to an embodiment of the present invention;

FIG. 3 is a flowchart showing an antitheft method for motorcycles according to an embodiment of the present invention; and

FIG. 4 is a flowchart showing an antitheft method for motorcycles according to another embodiment of the present invention.

### DETAILED DESCRIPTION OF THE PREFERRED EMBODIMENTS

Hereinafter, the present invention will be described in detail by explaining preferred embodiments of the invention with reference to the attached drawings. Like reference numerals in the drawings denote like elements.

In the specification, “power connection or engine start-up before authentication” means power connection or engine start-up when authentication between an electronic control unit and a smart remote controller is not performed.

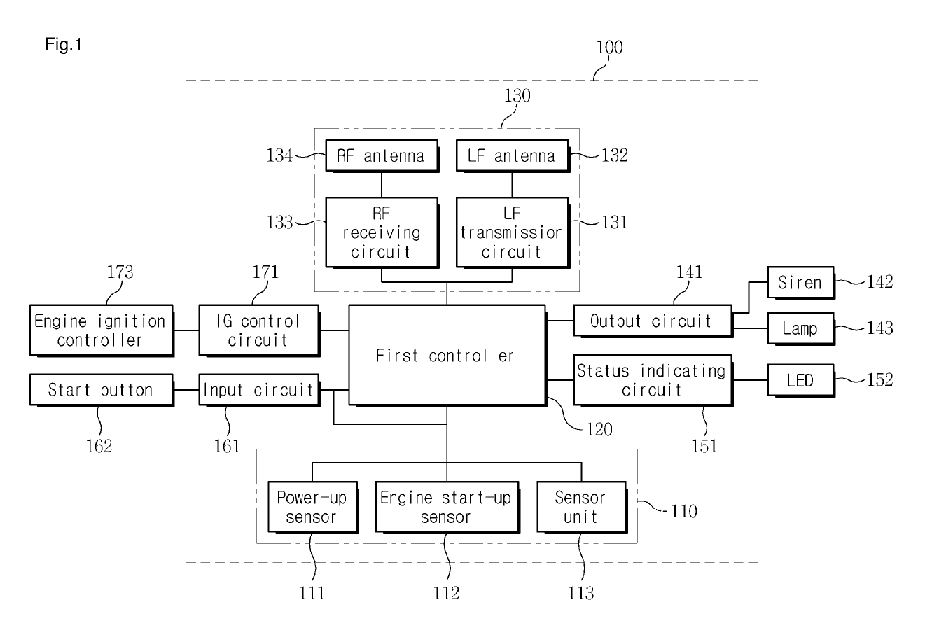

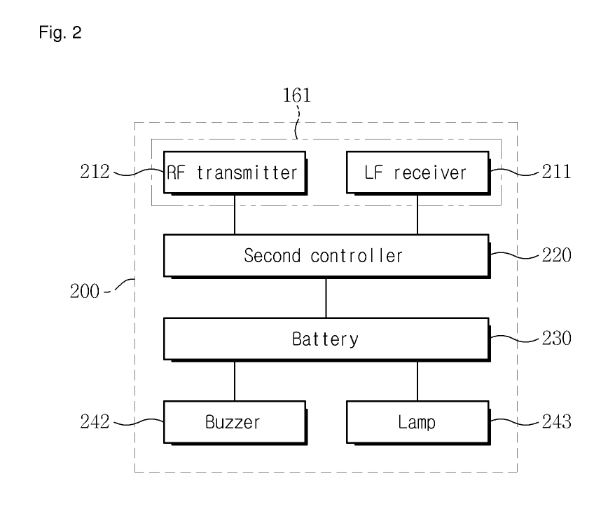

FIG. 1 is a block diagram of an electronic control unit 100 according to an embodiment of the present invention and FIG. 2 is a block diagram of a smart remote controller 200 according to an embodiment of the present invention.

Referring to FIG. 1, the electronic control unit 100 according to an embodiment of the present invention includes a sensing unit 110, a first controller 120 and a first radio communication unit 130. When power-up or engine start-up before authentication is performed through an illegal method, the electronic control unit 100 cuts off the power-up or engine start-up.

The sensing unit 110 includes a power-up sensor 111, an engine start-up sensor 112 and a sensor unit 113. The power-up sensor 111 senses whether a motorcycle is powered up. The engine start-up sensor 112 senses whether the engine of the motorcycle is started. The sensor unit 113 includes a pressure sensor and a motion sensor. The pressure sensor senses pressure or weight applied to a seat of the motorcycle to sense whether a person sits on the seat. The motion sensor senses whether the motorcycle is tilted to the left or right at greater than a predetermined angle and whether the front or rear wheel of the motorcycle is lifted at greater than a predetermined angle. Here, the motion sensor includes at least one of an acceleration sensor, an angular velocity sensor, a terrestrial magnetism sensor and a gyro sensor. However, the present invention is not limited thereto. The sensing unit 110 notifies the first controller 120 of power-up or engine start-up before authentication when the power-up or engine start-up is sensed. Further, the sensor unit 113 transmits a sensing signal to the first controller 120.

The first radio communication unit 130 includes a low frequency (LF) transmission circuit 131, an LF antenna 132, a radio frequency (RF) receiving circuit 133, and an RF antenna 134. The LF transmission circuit 131 transmits an electronic identifier of the electronic control unit 100 to a smart remote controller 200 which will be described in detail with reference to FIG. 2 through the LF antenna 132. In another embodiment of the invention, the LF transmission circuit 131 can transmit an electronic identifier transmission request signal to the smart remote controller 200. The RF receiving circuit 133 receives a response signal from the smart remote controller 200 through the RF antenna 134.

Although the electronic control unit 100 transmits signals through LF and receives signals through RF in the current embodiment of the invention, the present invention is not limited thereto. For example, the electronic control unit 100 can transmit and receive signals through LF, transmit and receive signals through RF, or transmit signals through RF and receive signals through LF.

When the first controller 120 determines that unauthenticated power-up or engine start-up is performed, an output circuit 141 can generate a theft alarm signal. The theft alarm signal can be generated by using a siren 142 or a lamp 143. Further, even if a key cylinder is on by using a replica key or an illegal method to supply power to electronic devices of the motorcycle, the first controller 120 does not start the engine until authentication is performed even when a start button 162 is pressed.

The first controller 120 can control the output circuit 141 to generate the theft alarm signal when the first controller 120 receives a sensing signal from the motor sensor of the sensor unit 113 in an alarm mode. When the motion sensor senses titling of the motorcycle to the left or right at greater than a predetermined angle or lifting of the front or rear wheel of the motorcycle at greater than a predetermine angle, the motion sensor outputs a sensing signal corresponding to the tilting or lifting to the first controller 120. Then, the first controller 120 controls the output circuit 141 to generate the theft alarm signal.

The first controller 120 can automatically perform warning, cancellation of warning, power-up and start-up through radio communication with the smart remote controller 200 via the first radio communication unit 130. Of course, the first controller 120 automatically carries out radio communication with the smart remote controller 200 which passes authentication. When authentication through the smart remote controller 200 is successful, the first controller 120 automatically cancels predetermined handle lock. When the engine cuts off and the motorcycle enters the alarm mode, the first controller 120 sets the handle lock.

When the first controller 120 receives a pressure sensing signal from the pressure sensor of the sensor unit 113 or senses a braking operation, the first controller 120 can start authentication of the smart remote controller 200. For example, the first controller 120 can transmit the electronic identifier of the electronic control unit 100 to the smart remote controller 200 or requests the smart remote controller 200 to transmit the electronic identifier of the smart remote controller 200.

The first controller 120 maintains a sleep state while the motorcycle engine cuts off. That is, the first controller 120 maintains the sleep state during a period for which a battery of the motorcycle is in danger of discharging while the motorcycle engine cuts off. Further, the first controller 120 can check a battery voltage of the motorcycle and, when the motorcycle is in danger of battery discharging, notify a user of the danger of battery discharging through the siren 142, the lamp 143 or an LED 152.

The LED 152 indicates an operating state of the motorcycle. The first controller 120 can control a status indicating circuit 151 to operate the LED 152.

The electronic control unit 100 according to the current embodiment of the invention can be attached to the motorcycle when the motorcycle is manufactured. If the electronic control unit 100 is attached to a finished motorcycle, there is no need to additionally attach the lamp 143, the start button 162 and the siren 142 to the motorcycle and those previously attached to the motorcycle can be used. Accordingly, the electronic control unit 100 can be conveniently mounted in the motorcycle.

Referring to FIG. 2, the smart remote controller 200 according to an embodiment of the present invention includes a second radio communication unit 210, a second controller 220, a battery 230, a buzzer 242, and a lamp 243. The second radio communication unit 210 includes an LF receiver 211 and an RF transmitter 212. The LF receiver 211 receives the electronic identifier of the electronic control unit 100, transmitted from the electronic control unit 100. In another embodiment of the invention, the LF receiver 211 can receive a smart remote controller electronic identifier transmission request signal from the electronic control unit 100. The RF transmitter 212 transmits a response signal of the smart remote controller 200 to the electronic control unit 100.

The second controller 220 determines whether the electronic identifier of the electronic control unit 100, received through the LF receiver 211, is identical to the electronic identifier of the smart remote controller 200. When the electronic identifier of the electronic control unit 100 is not identical to the electronic identifier of the smart remote controller 200, the second controller 220 does not respond to the electronic control unit 100. When the electronic identifier of the electronic control unit 100 is identical to the electronic identifier of the smart remote controller 200, the second controller 220 controls the RF transmitter 212 to transmit a response signal including the electronic identifier of the smart remote controller 200 to the electronic control unit 100.

Further, the second controller 220 maintains a sleep state until an electronic identifier request signal is received from the electronic control unit 100. The second controller 220 can check the voltage of a battery 230 of the smart remote controller 200 and notify the user of a battery change time through the lamp 243. The second controller 220 does not send an unnecessary response when the second controller 220 receives an electronic identifier request from an electronic control unit of a motorcycle other than the authenticated electronic control unit 100 of the motorcycle, and thus signal collision can be prevented. The second controller 220 can receive the theft alarm signal from the electronic control unit 100 through the LF receiver 211 and output a theft alarm. For example, the second controller 220 can raise the theft alarm through the buzzer 242 or the lamp 243 to notify the user that the motorcycle is in danger of being stolen. Here, the lamp 243 can use an LED.

When the user wants to ride the motorcycle, the user presses the start button 162 while carrying the smart remote controller 200. In another embodiment of the invention, the user can insert the key into the key cylinder, turn the key cylinder to ‘ON’ position, and then press the start button 162 or step on the kick start to start the motorcycle. Here, the key cylinder may be one of a 2-pin and 4-pin type key cylinder.

A signal of the start button 162 is transmitted to the first controller 120 through an input circuit 161. The sensing unit 110 senses motorcycle power-up or engine start-up. Even if the motorcycle is powered up or the motorcycle engine is started through an illegal method, the sensing unit 110 senses the illegal power-up or engine start-up. When the sensing unit 110 senses the power-up or engine start-up, the first controller 120 transmits the electronic identifier of the electronic control unit 100 to the smart remote controller 200 through the first radio communication unit 130.

The smart remote controller 200 receives the electronic identifier of the electronic control unit 100 through the LF receiver 211. The second controller 220 determines whether the received electronic identifier of the electronic control unit 100 is identical to the electronic identifier of the smart remote controller 200. When the received electronic identifier of the electronic control unit 100 is not identical to the electronic identifier of the smart remote controller 200, the second controller sends no response. When the received electronic identifier of the electronic control unit 100 correspond to the electronic identifier of the smart remote controller 200, the second controller 220 transmits a response signal including the electronic identifier of the smart remote controller 200 to the electronic control unit 100 through the RF transmitter 212. In this manner, the smart remote controller 200 responds to only the electronic control unit 100 having the electronic identifier identical to that of the smart remote controller 200, and thus an unnecessary operation can be prevented.

The first controller 120 of the electronic control unit 100 determines that illegal power-up or engine start-up is performed and cuts off the power-up or engine start-up if the first controller 120 does not receive the response signal through the first radio communication unit 130 for a predetermined time. The first controller 120 can ground the output of an IG control circuit 171 to the ground in order to cut off the engine. That is, the electronic control unit 100 can ground the output of the IG control circuit to the ground such that AC power supplied to an engine ignition controller 173 from a generator to the ground so as to stop the engine or cut off DC power supplied to the engine ignition controller 173 so as to stop the engine. For example, the engine ignition controller 173 may use one of capacitor discharge ignition (CDI), DC-CDI and injection using the electronic control unit 100.

In the case of a motorcycle using the CDI type engine ignition controller 173, AC power supplied to the engine ignition controller 173 or AC power supplied to an ignition coil can be grounded to the ground to stop engine start-up. A 4-pin type key cylinder can be used the CDI type engine ignition controller,

In the case of a motorcycle using the DC-CDI type engine ignition controller 173, DC power supplied to the engine ignition controller 173 can be cut off by using a switch or a relay to stop engine start-up. A 2-pin type key cylinder can be used for the DC-CDI engine ignition controller. Further, the DC-CDI type engine ignition controller 173 performs a function of stopping engine start-up when a specific pin is grounded to the ground according to the type.

In the case of a motorcycle employing the injection type engine ignition controller 173 using the electronic control unit 100, DC power supplied to the ignition coil can be cut by using a switch or a relay to stop the engine start-up. For the injection type engine ignition controller, a 2-pin type key cylinder can be used.

As described above, a relay or a switch can be additionally connected between the IG control circuit 171 and the engine ignition controller 173 according to motorcycle type to control starting of the aforementioned engine ignition controllers 173 of three types by using the IG control circuit 171.

The first controller 120 can control the output circuit 141 to output the theft alarm signal. The theft alarm signal may correspond to the siren 142 or light emitted from the lamp 143.

When the first controller 120 receives the response signal through the first radio communication unit 130, the first controller 120 determines whether the electronic identifier of the smart remote controller 200, included in the response signal, is identical to the electronic identifier of the electronic control unit 100. When the electronic identifier of the smart remote controller 200 is identical to the electronic identifier of the electronic control unit 100, the first controller 120 maintains start-up of the engine.

When the user wants to stop the motorcycle, he or she should stop start-up of the motorcycle engine. A stop button may be used to stop start-up of the motorcycle engine. The user can press the stop button to stop the motorcycle engine after he or she ends driving of the motorcycle.

Another method of stopping the motorcycle engine stops the engine when the user presses the start button 162 for longer than a predetermined time while engine start-up is sensed. In this case, the additional stop button is not required.

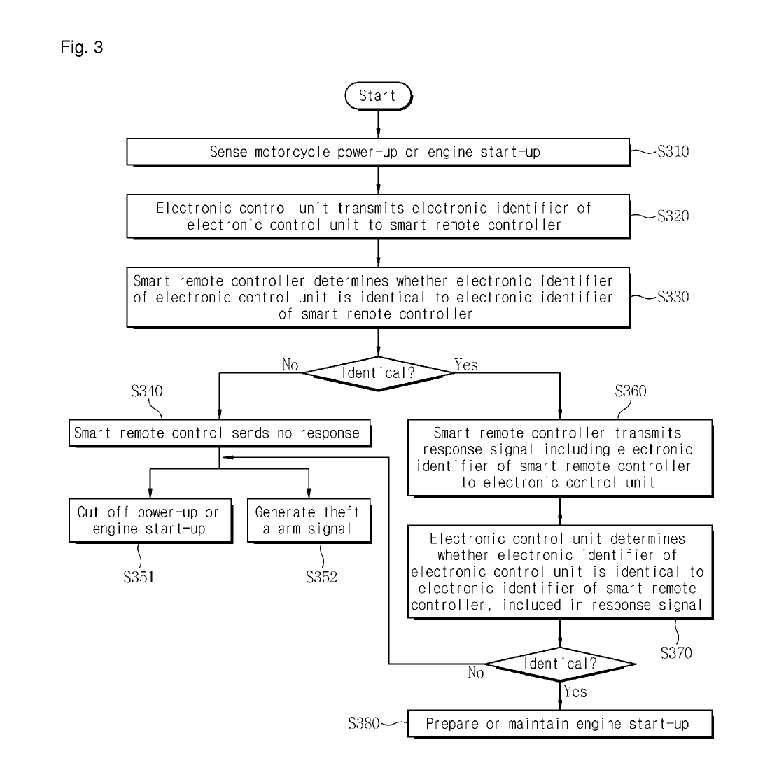

FIG. 3 is a flowchart showing an antitheft method for motorcycles according to an embodiment of the present invention.

Referring to FIGS. 1, 2 and 3, the electronic control unit 100 of the motorcycle senses power-up of the motorcycle or engine start-up before authentication in step S310. The power-up of the motorcycle and engine start-up can be sensed by the sensing unit 110. When the power-up or engine start-up is sensed, the electronic control unit 100 transmits the electronic identifier of the electronic control unit 100 to the smart remote controller 200 in step S320. The electronic identifier of the electronic control unit 100 can be transmitted through the LF transmission circuit 131 and the LF antenna 132. The smart remote controller 200 can receive the electronic identifier of the electronic control unit 100 through the LF receiver 211. The smart remote controller 210 determines whether the received electronic identifier of the electronic control unit 100 is identical to the electronic identifier of the smart remote controller 200 in step S330.

Here, if a pressure sensing signal is received from the pressure sensor attached to the seat of the motorcycle or a braking operation is sensed in step S320, the electronic control unit 100 can transmit the electronic identifier of the electronic control unit 100 to the smart remote controller 200 through radio communication.

When the electronic identifier of the electronic control unit 100 is not identical to the electronic identifier of the smart remote controller 200, the smart remote controller 200 does not respond to the electronic control unit 100 in step S340. In this manner, the smart remote controller 200 responds to only the electronic control unit 100 having the electronic identifier identical to that of the smart remote controller 200, and thus an unnecessary operation can be prevented from being performed. Accordingly, signal collision can be prevented. When the smart remote controller 200 does not respond to the electronic control unit 100, the electronic control unit 100 cannot receive a response signal within a predetermined time. The electronic control unit 100 cuts off power-up of the motorcycle or stops engine start-up if the response signal is not received in step S351. In the current embodiment of the invention, the electronic control unit 100 can ground the output of the IG control circuit 171 to the ground to make AC power supplied to the engine ignition controller from a generator drain to the ground so as to stop the engine or cut off DC power supplied to the engine ignition controller so as to stop the engine. In another embodiment of the invention, the engine can be stopped through other methods. That is, the present invention can prevent the motorcycle from being illegally started by cutting off power-up or engine start-up.

Further, electronic control unit 100 generates a theft alarm signal in step S352. The theft alarm signal may correspond to the siren 142 or flicking of the lamp 143. The theft alarm signal informs people that the motorcycle is in danger of being stolen to prevent the motorcycle from being stolen.

The electronic control unit 100 maintains a predetermined handle lock state in step S340.

When the electronic identifier of the electronic control unit 100 is identical to the electronic identifier of the smart remote controller 200, the smart remote controller 200 transmits the response signal to the electronic control unit 100 in step S360. The response signal includes the electronic identifier of the smart remote controller 200. The response signal can be transmitted through the RF transmitter 212. The electronic control unit 100 can receive the response signal from the smart remote controller 200 through the RF antenna 134 and the RF receiving circuit 133. The electronic control unit 100 determines whether the electronic identifier of the smart remote controller 200, which is included in the response signal, is identical to the electronic identifier of the electronic control unit 100 in step S370. In this manner, the electronic control unit 100 also determines whether the electronic identifiers of the electronic control unit 100 and the smart remote controller 200 are identical to each other, and thus safer security can be achieved. For example, if only the smart remote controller 200 determines whether the electronic identifiers of the electronic control unit 100 and the smart remote controller 200 are identical to each other, a person having illegal purpose can easily steal the motorcycle by operating the smart remote controller 200. To prevent this, the electronic control unit 100 is required to determine whether the electronic identifiers of the electronic control unit 100 and the smart remote controller 200 are identical to each other.

If the electronic identifiers of the electronic control unit 100 and the smart remote controller 200 are not identical to each other, the electronic control unit 100 cuts off motorcycle power-up or engine start-up in step S351. Further, the electronic control unit 100 generates the theft alarm signal in step S352. If the electronic identifiers of the electronic control unit 100 and the smart remote controller 200 are identical to each other, the electronic control unit 100 prepares or maintains engine start-up in step S380. The electronic control unit 100 maintains the predetermined handle lock state when the electronic identifiers of the electronic control unit 100 and the smart remote controller 200 are not identical to each other. On the other hand, the electronic control unit 100 cancels the predetermined handle lock state when the electronic identifiers of the electronic control unit 100 and the smart remote controller 200 are identical to each other.

If the motion sensor of the sensor unit 113 senses tilting of the motorcycle to the left or right at greater than a predetermined angle or lifting of the front or rear wheel of the motorcycle at greater than a predetermined angle in step S310, the motion sensor outputs a sensing signal to the electronic control unit 100. When the electronic control unit 100 receives the sensing signal, the electronic control unit 100 can generate the theft alarm signal and output the theft alarm signal through the output circuit 141.

The electronic control unit 100 can transmit the theft alarm signal to the authenticated smart remote controller 200 in step S352. When the smart remote controller 200 receives the theft alarm signal, the smart remote controller 200 can output a theft alarm through the buzzer 242 or the lamp 243 to inform the user that the motorcycle is in danger or being stolen.

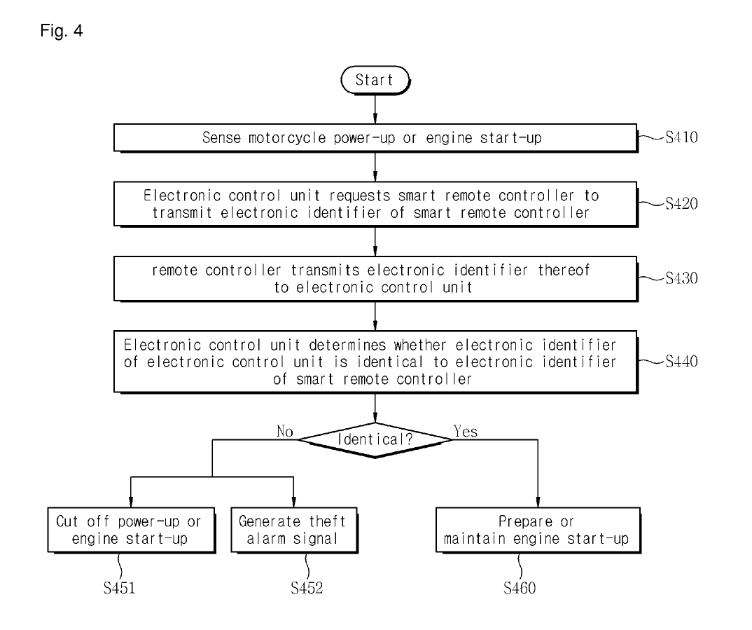

FIG. 4 is a flowchart showing an antitheft method for motorcycles according to another embodiment of the present invention.

Referring to FIG. 4, the electronic control unit 100 senses motorcycle power-up or engine start-up before authentication in step S410. The motorcycle power-up or engine start-up can be sensed by the sensing unit 110. When the motorcycle power-up or engine start-up is sensed, the electronic control unit 100 requests the smart remote controller 200 to transmit the electronic identifier of the smart remote controller 200 in step S420. Here, the electronic control unit 100 requests the smart remote controller 200 to transmit the electronic identifier of the smart remote controller 200 through the first radio communication unit 130. The smart remote controller 200 transmits the electronic identifier thereof to the electronic control unit 100 at the request of the electronic control unit 100 in step S430. The smart remote controller 200 can transmit the electronic identifier thereof through the second radio communication unit 210. The electronic control unit 100 receives the electronic identifier of the smart remote controller 200 and determines whether the electronic identifier of the electronic control unit 100 is identical to the electronic identifier of the smart remote controller 200 in step S440.

If a pressure sensing signal is received from the pressure sensor attached to the seat of the motorcycle or a braking operation is sensed in step S420, the electronic control unit 100 can request the smart remote controller 200 to transmit the electronic identifier of the smart remote controller 200 through radio communication.

When the electronic identifier of the electronic control unit 100 is not identical to the electronic identifier of the smart remote controller 200, the electronic control unit 100 cuts off motorcycle power-up or engine start-up in step S451. Further, the electronic control unit 100 generates a theft alarm signal in step S452. When the electronic identifier of the electronic control unit 100 is identical to the electronic identifier of the smart remote controller 200, the electronic control unit 10 prepares or maintains engine start-up in step S460.

The antitheft method for motorcycles according to the current embodiment of the invention can achieve rapid authentication as compared to the antitheft method for motorcycles described with reference to FIG. 3.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. An antitheft method for motorcycles, comprising:
a step in which an electronic control unit senses power-up of a motorcycle or engine start-up before authentication;
a step in which the electronic control unit transmits an electronic identifier of the electronic control unit to a smart remote controller through radio communication; and
a step in which the electronic control unit cuts off the motorcycle power-up or engine start-up when the electronic control unit does not receive a response signal to the electronic identifier of the electronic control unit from the smart remote controller.

2. An antitheft method for motorcycles, comprising:
a step in which an electronic control unit senses power-up of a motorcycle or engine start-up before authentication;
a step in which the electronic control unit requests a smart remote controller to transmit an electronic identifier of the smart remote controller through radio communication; and
a step in which the electronic control unit cuts off the motorcycle power-up or engine start-up when the electronic control unit does not receive the electronic identifier of the smart remote controller within a predetermined period of time.

3. The antitheft method for motorcycles of claim 1, wherein the electronic control unit generates a theft alarm signal in the step of cutting off the motorcycle power-up or engine start-up.

4. The antitheft method for motorcycles of claim 1, wherein the electronic control unit grounds the output of an IG control circuit to the ground to ground AC power supplied to an engine ignition controller of the motorcycle to the ground or cuts off DC power supplied to the engine ignition controller so as to stop the engine start-up in the step of cutting off the motorcycle power-up or engine start-up.

5. The antitheft method for motorcycles of claim 1, further comprising:
a step of determining whether the electronic identifier of the electronic control unit, received by the smart remote controller, is identical to the electronic identifier of the smart remote controller; and
a step in which the smart remote controller sends no response when the electronic identifier of the electronic control unit is not identical to the electronic identifier of the smart remote controller.

6. The antitheft method for motorcycles of claim 5, further comprising:
a step in which the smart remote controller transmits a response signal including the electronic identifier of the smart remote controller to the electronic control unit; and
a step in which the electronic control unit determines whether the electronic identifier of the smart remote controller, which is included in the response signal, is identical to the electronic identifier of the electronic control unit and, when the electronic identifier of the smart remote controller is identical to the electronic identifier of the electronic control unit, prepares or maintains engine start-up if the electronic identifier of the smart remote controller is identical to the electronic identifier of the electronic control unit.

7. The antitheft method for motorcycles of claim 5, further comprising:
a step in which the electronic control unit maintains a predetermined handle lock state when the electronic identifier of the smart remote controller is not identical to the electronic identifier of the electronic control unit; and
a step in which the electronic control unit cancels the predetermined handle lock state when the electronic identifier of the smart remote controller is identical to the electronic identifier of the electronic control unit.

8. The antitheft method for motorcycles of claim 1, wherein the electronic control unit does not start the engine of the motorcycle if a start button is pressed within the predetermined period of time for which the electronic control unit does not receive the response signal or the electronic identifier of the smart remote controller in the step of cutting off the motorcycle power-up or engine start-up.

9. The antitheft method for motorcycles of claim 2, further comprising:
a step in which the electronic control unit receives the electronic identifier of the smart remote controller from the smart remote controller;
a step in which the electronic control unit determines whether the electronic identifier of the smart remote controller is identical to the electronic identifier of the electronic control unit; and
a step in which the electronic control unit performs the step of cutting off the motorcycle power-up or engine start-up when the electronic identifier of the smart remote controller is not identical to the electronic identifier of the electronic control unit and prepares or maintains engine start-up when the electronic identifier of the smart remote controller is identical to the electronic identifier of the electronic control unit.

10. The antitheft method for motorcycles of claim 1, wherein, in the step of transmitting the electronic identifier of the electronic control unit to the smart remote controller, the electronic control unit transmits the electronic identifier of the electronic control unit to the smart remote controller through radio communication when a pressure sensing signal is received from a pressure sensor attached to a seat of the motorcycle or a braking operation is sensed.

11. The antitheft method for motorcycles of claim 2, wherein, in the step of requesting the smart remote controller to transmit the electronic identifier of the smart remote controller, the electronic control unit requests the smart remote controller to transmit the electronic identifier of the smart remote controller through radio communication when a pressure sensing signal is received from a pressure sensor attached to a seat of the motorcycle or a braking operation is sensed.

12. The antitheft method for motorcycles of claim 1, wherein the electronic control unit senses tilting of the motorcycle to the left or right at greater than a predetermined angle or lifting of the front or rear wheel of the motorcycle at greater than a predetermined angle in the step of sensing the power-up or engine start-up before authentication, and the electronic control unit generates a theft alarm signal in the step of cutting off the power-up or engine start-up.

13. The antitheft method for motorcycles of claim 1, wherein the electronic control unit transmits the theft alarm signal to an authenticated smart remote controller to raise a theft alarm.

14. An antitheft system for motorcycles, comprising:
an electronic control unit sensing motorcycle power-up or engine start-up before authentication and transmitting/receiving an electronic identifier; and
a smart remote controller receiving an electronic identifier from the electronic control unit, transmitting a response signal and determining whether the received electronic identifier of the electronic control unit is identical to an electronic identifier of the smart remote controller,
wherein the electronic control unit transmits the electronic identifier of the electronic control unit to the smart remote controller when sensing motorcycle power-up or engine start-up,
the smart remote controller receives the electronic identifier of the electronic control unit, determines whether the received electronic identifier of the electronic control unit is identical to the electronic identifier of the smart remote controller, sends no response if the received electronic identifier of the electronic control unit is not identical to the electronic identifier of the smart remote controller, and transmits the response signal including the electronic identifier of the smart remote controller to the electronic control unit if the received electronic identifier of the electronic control unit is identical to the electronic identifier of the smart remote controller,
the electronic control unit cuts off motorcycle power-up or engine start-up if the response signal is not received within a predetermined time, determines whether the electronic identifier of the smart remote controller, which is included in the response signal, is identical to the electronic identifier of the electronic control unit if the response signal is received, and prepares or maintains engine start-up when the electronic identifier of the smart remote controller is identical to the electronic identifier of the electronic control unit.

15. The antitheft system for motorcycles of claim 14, wherein the electronic control unit generates a theft alarm signal when the response signal is not received within the predetermined time.

16. The antitheft system for motorcycles of claim 14, wherein the electronic control unit comprises:
a sensing unit sensing motorcycle power-up or engine start-up;
a first controller determining whether the electronic identifier of the smart remote controller is identical to the electronic identifier of the electronic control unit; and
a first radio communication unit transmitting/receiving the electronic identifiers.

17. The antitheft system for motorcycles of claim 14, wherein the smart remote controller comprises:
a second radio communication unit receiving the electronic identifier of the electronic control unit and transmitting the response signal; and
a second controller determining whether the electronic identifier of the smart remote controller is identical to the electronic identifier of the electronic control unit.

18. The antitheft system for motorcycles of claim 14, wherein the electronic control unit grounds the output of an IG control circuit to the ground to ground AC power supplied to an engine ignition controller of the motorcycle to the ground or cuts off DC power supplied to the engine ignition controller so as to stop the engine start-up in the step of cutting off the motorcycle power-up or engine start-up.

19. The antitheft system for motorcycles of claim 14, wherein the electronic control unit maintains a sleep state while the motorcycle engine is cut off.

20. The antitheft system for motorcycles of claim 14, wherein the electronic control unit checks a battery voltage of the motorcycle and notifies a user of a battery change time.
